(19) United States
(12) Patent Application Publication
(10) Pub. No.: US 2019/0095583 A1
(43) Pub. Date: Mar. 28, 2019

(54) METHOD AND SYSTEM FOR ELECTRONIC MEDICAL RECORD PROCESSING IN PRESENCE OF CONFLICTS

(71) Applicant: Konica Minolta Healthcare Americas, Inc., Wayne, NJ (US)

(72) Inventor: Hiroyuki Kubota, Wayne, NJ (US)

(73) Assignee: Konica Minolta Healthcare Americas, Inc., Wayne, NJ (US)

(21) Appl. No.: 15/717,395

(22) Filed: Sep. 27, 2017

(51) Int. Cl. G06F 19/00

(52) U.S. Cl. CPC G06F 19/322; G06F 19/3431

(57) ABSTRACT

A method for electronic medical record processing in presence of conflicts. The method includes obtaining, from a first local source, a first action to be performed on an electronic medical record stored in a central electronic medical record database and making a first determination that a first conflict exists in the electronic medical record. Based on the first determination the severity of the first conflict in view of the first action to be performed is assessed. The first conflict is deemed severe if the first conflict prevents execution of the first action, and the first conflict is deemed non-severe if the first conflict does allow execution of the first action. The method further includes making a second determination that the first conflict is non-severe, and based on the second determination, performing the first action on the electronic medical record.

### BACKGROUND

Electronic medical records, including medical images and other medical data play a crucial role in the diagnosis of patients. Healthcare facilities (e.g., hospitals) have realized the benefits of electronically storing medical records. The digitalization of medical images and other data not only enables users to easily access the medical images and medical data, but also enables the images and data to be easily shared between multiple healthcare facilities.

In the healthcare industry, the use of a system known as a Picture Archiving and Communications System (“PACS”) is becoming increasingly popular for convenient storage and access of medical images. Generally, a PACS comprises a multitude of devices working cooperatively to digitally capture, store, manage, distribute, and display medical images generated by various imaging modalities, such as computed tomography (CT), magnetic resonance imaging (MRI), position emission tomography (PET), ultrasound, X-ray, etc. PACS allows various healthcare facilities to share all types of images captured internally or externally.

More recently, cloud-based PACS have emerged as a way to improve efficiency and accessibility of traditional PACS. In general, a “cloud” can be understood as an online storage system that provides remote, on-demand access of computing resources and data over the Internet to multiple computers and devices in various locations. Cloud-based PACS may be provided by vendors who use remote or off-site data centers in various locations for storage of medical images.

The above-described concepts are not limited to image data. For example, any other type of medical data such as lab tests and results may be acquired, processed and stored in a similar manner. Generally speaking, the above-described concepts are applicable to any type of electronic medical records that may include any types of image data and/or any types of non-image data.

### SUMMARY

In general, in one aspect, the invention relates to a method for electronic medical record processing in presence of conflicts, comprising: obtaining, from a first local source, a first action to be performed on an electronic medical record stored in a central electronic medical record database; making a first determination that a first conflict exists in the electronic medical record, and based on the first determination: assessing the severity of the first conflict in view of the first action to be performed, wherein the first conflict is deemed severe if the first conflict prevents execution of the first action, and wherein the first conflict is deemed non-severe if the first conflict does allow execution of the first action; and making a second determination that the first conflict is non-severe, and based on the second determination, performing the first action on the electronic medical record.

In general, in one aspect, the invention relates to a non-transitory computer readable medium (CRM) storing instructions that cause a computing system to perform an operation for electronic medical record processing in presence of conflicts, comprising: obtaining, from a first local source, a first action to be performed on an electronic medical record stored in a central electronic medical record database; making a first determination that a first conflict exists in the electronic medical record, and based on the first determination: assessing the severity of the first conflict in view of the first action to be performed, wherein the first conflict is deemed severe if the first conflict prevents execution of the first action, and wherein the first conflict is deemed non-severe if the first conflict does allow execution of the first action; and making a second determination that the first conflict is non-severe, and based on the second determination, performing the first action on the electronic medical record.

In general, in one aspect, the invention relates to a system that processes electronic medical records in presence of conflicts, comprising a central server; and a central repository associated with the central server, wherein the central server: obtains, from a first local source, a first action to be performed on an electronic medical record stored in a central electronic medical record database in the central repository; makes a first determination that a first conflict exists in the electronic medical record, and based on the first determination: assesses the severity of the first conflict in view of the first action to be performed, wherein the first conflict is deemed severe if the first conflict prevents execution of the first action, and wherein the first conflict is deemed non-severe if the first conflict does allow execution of the first action; and makes a second determination that the first conflict is non-severe, and based on the second determination, performs the first action on the electronic medical record.

### BRIEF DESCRIPTION OF DRAWINGS

FIG. 1 shows a schematic diagram of a system in accordance with one or more embodiments of the invention.

FIG. 2 shows an exemplary electronic medical record in accordance with one or more embodiments of the invention.

FIGS. 3A and 3B show exemplary scenarios in which a conflict in the electronic medical record data is non-severe, in accordance with one or more embodiments of the invention.

FIG. 4 shows an exemplary scenario in which a conflict in the electronic medical record data is severe, in accordance with one or more embodiments of the invention.

FIG. 5 shows a hierarchical representation of an exemplary electronic medical record, in accordance with one or more embodiments of the invention.

FIG. 6 shows a flowchart illustrating a method for electronic medical record processing in presence of conflicts, in accordance with one or more embodiments of the invention.

FIG. 7 shows a flowchart illustrating a method for assessing a severity of a conflict in accordance with one or more embodiments of the invention.

FIG. 8 shows a flowchart illustrating a method for performing a conflict resolution in accordance with one or more embodiments of the invention.

FIG. 9 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Like elements may not be labeled in all figures for the sake of simplicity.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.)

may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments of the invention may be combined with other dependent claims.

In general, one or more embodiments of the invention provide a method, a non-transitory computer readable medium and a system configured for storing electronic medical records and for local-to-cloud synchronization of electronic medical records, including a mechanism for addressing conflicts during synchronization. A “conflict” generally refers to a disagreement or incompatibility that occurs between data of the medical record during synchronization. The cloud-based system, e.g., a PACS, in accordance with one or more embodiments of the invention enables all healthcare facilities that are given permission to access a cloud data repository or database (“cloud repository”), such as facilities within the same hospital group, to share medical images and/or other data. The medical images and/or other data may be stored in an electronic medical record. A healthcare facility would then be able to access and retrieve its patients' medical images and/or other data obtained at the other healthcare facilities that are “in-network” (i.e., having permission to access the same portion of the cloud repository). Specifically, according to one or more embodiments of the invention, in-network healthcare facilities can more effectively utilize the cloud-based PACS to share and update medical images and/or other data for patients who frequent multiple of the in-network healthcare facilities (i.e., a shared or common patient between two or more in-network healthcare facilities). Conflicting data may occur, for example, if the same data field in an electronic medical record is accessed by two healthcare facilities, and conflicting data are entered. Consider, for example, a scenario in which a patient named Bob visits an ophthalmologist and a dermatologist. The ophthalmologist verifies Bob's basic patient information, including his name and further enters some diagnostic results into Bob's existing electronic medical record. The entered information is locally stored. Later, Bob visits the dermatologist, where Bob's basic patient information is also verified. The dermatologist confuses Bob with another patient named John and therefore updates the name in Bob's electronic medical record to “John”. This results in conflicting information which is eventually detected when the electronic medical records, locally stored on computer systems of the ophthalmologist's and the dermatologist's office are synchronized to the central cloud repository. Further, consider a different scenario, in which a folder used for storing patient medical images is deleted by an employee of a first healthcare facility, while an attempt is made by an employee of a second healthcare facility to store images in the now-deleted folder. This conflict, until resolved, may prevent the storage of these images.

One or more embodiments of the invention enable the processing of electronic medical health records in presence of certain conflicts. After the detection of the conflict, the severity of the conflict is assessed to determine whether continued processing is possible. If the execution of a pending action is found to be possible, the pending action is performed, in accordance with one or more embodiments of the invention. Alternatively, if the execution of a pending action if found to be impossible in presence of the conflict, a conflict resolution is performed, potentially enabling subsequent execution of the pending action, in accordance with one or more embodiments of the invention.

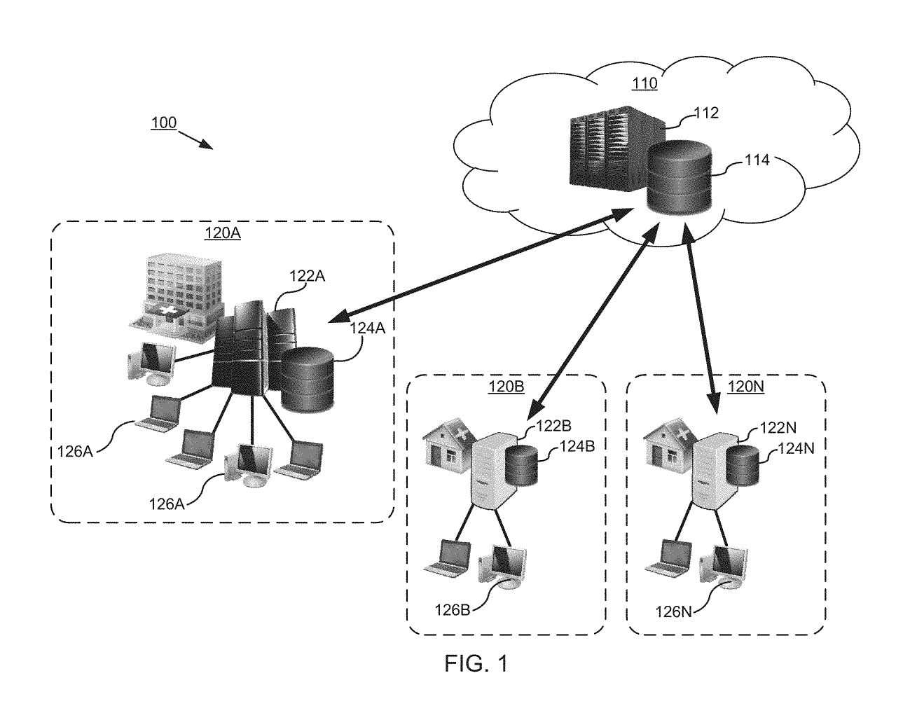

FIG. 1 shows a system (100) in accordance with one or more embodiments of the invention. The system (100) includes a cloud (110) that includes a cloud server (112) with a cloud repository (114). The system further includes multiple sites (120A-120N), in accordance with an embodiment of the invention. Each site may be a healthcare facility, e.g., a public or private hospital, a medical clinic, a dental clinic, a doctor's office, etc. Each site (120A-120N) may be equipped with a local server (122A-122N) (e.g., an application proxy server (APS)) and a local repository (124A-124N)). Each of the multiple local servers (122A-122N) may be authorized to access/view the cloud server (112). In addition to the right to access the remote data on the cloud server (112), certain local servers (122A-122N) may also have the right to edit the remote data.

As also shown in FIG. 1, each healthcare facility in the system (100) includes one or more user computing devices (126A-126N) (herein referred to as “a local computer”) coupled to the local servers (122A-122N). A local computer (126A-126N) may be a personal computer (PC), a laptop, a mobile computing device (e.g., tablet PC, smartphone, etc.), a server, a mainframe, a kiosk, etc.

In one or more embodiments of the invention, the cloud server (112) with the cloud repository (114) may be operated by a vendor providing the cloud-based PACS or another third-party associated with such a vendor. In one or more embodiments of the invention, the cloud server (112) is a physical and/or virtual computing infrastructure that performs application and information processing. For example, the cloud server (112) may be a virtual server or a physical server accessed remotely via the Internet. In one or more embodiments of the invention, the cloud repository (114) is an online repository of data. For example, the cloud repository may be a virtual data room (VDR) or a database (or group of databases) accessed remotely via the Internet. The cloud repository (114) stores multiple electronic medical records. The cloud repository (114) may be structured, for example, as directory, or it may be a database designed to accommodate a number of electronic medical records, for example in a PACS.

In one or more embodiments of the invention, the cloud server (112) is configured to receive the medical images and/or other data transmitted from the local servers (122A-122N) and store the medical images and/or other data in the cloud repository (114) as remote data.

In one or more embodiments of the invention, each local server (122A-122N) is operated by the associated healthcare facility. The local server (122A-122N) is configured to transmit the medical images and/or other data received from the local computers (126A-126N) to the cloud repository (114) on the cloud server (112). Each local repository (124A-124N) is operated and maintained by the associated healthcare facility. The local repository (124A-124N) may locally store medical images and/or other data received from the local server (122A) and the cloud repository (114).

In one or more embodiments of the invention, the local computers (126A-126N) are operated by medical professionals associated with the respective healthcare facilities and are configured to transmit to the local server (122A-122N) medical images and/or other data taken from one or more modalities (not shown) in the healthcare facility. In one or more embodiments of the invention, the local computers (126A-126N) may be configured as the local server (122A-122N). In one or more embodiments of the invention, one or more of the local computers (126A-126N) may also include the local repository (124A-124N).

In one or more embodiments of the invention, the local computers (126A-126N) are configured to store an application provided by the vendor that operates the cloud (110). In one or more embodiments of the invention, the application may be provided by a third-party associated with the vendor. The application may be an independent software application or a web-browser based application with a graphical user interface (“GUI”) that allows the local computers (126A-126N) to access the cloud (110).

In the exemplary system (100) shown in FIG. 1, the multiple in-network healthcare facilities (120A-120N) may communicate bilaterally with the cloud (110), in accordance with one or more embodiments of the invention. As shown in FIG. 1, the in-network healthcare facilities may transmit locally-obtained medical images and/or other data to the cloud (110) to be stored as remote data in the cloud repository (114) accessible to other in-network healthcare facilities. In one or more embodiments of the invention, the in-network healthcare facilities may retrieve medical images and/or other data from the cloud (110) to be stored as local data in their respective local repositories (124A-124N).

In one or more embodiments of the invention, not all of the remote data stored in the cloud repository (114) need be retrieved by the in-network healthcare facilities to be stored as local data. The remote data to be retrieved and stored as local data may vary based on the size and need of the healthcare facility or on the preferences of the local computers (126A-126N) (or on the preferences of the healthcare professionals using the local computers). For example, the remote data to be retrieved and stored as local data in the local repositories (124A-124N) of certain in-network healthcare facilities may be based on specific individuals who are patients of those facilities. Thus, if a particular individual is not a patient of a particular in-network healthcare facility, that healthcare facility may not retrieve and store that patient's medical images and/or other data from the cloud (110) as local data. This option may be particularly useful for smaller healthcare facilities with smaller local servers (122A-122N) and local repositories (124A-124N) with limited storage and processing power. In one or more embodiments of the invention, the remote data to be retrieved and stored as local data in the local repositories (124A-124N) of certain in-network healthcare facilities may be based on a specific medical study, medical series, medical image, or medical report instead of being based on specific individuals who are patients of those facilities.

In one or more embodiments of the invention, users of the local computers (126A-126N) at each in-network healthcare facility may view the medical images and/or other data stored on the cloud repository (114) through a web-browser based version of the application that is stored on the cloud server (112). The user may also view the images through a local version of the application stored on the local computers (126A-126N). For example, healthcare professionals may determine whether any of the local data stored in the local repository (124A-124N) have been updated by another healthcare professional associated with a different in-network healthcare facility, and retrieve the updated data from the cloud repository (1114) to replace the current local data. In one or more embodiments of the invention, the updating of the local data may be performed automatically by the system (100), e.g., through the application stored on the local computers (126A-126N).

For example, an individual may be a patient at multiple in-network healthcare facilities. Each of these in-network healthcare facilities may store the individual's medical images and/or other data as local data. In one or more embodiments of the invention, when the individual's medical images and/or other data are updated in the cloud repository (114) by one of the in-network healthcare facilities, the other in-network healthcare facilities where the individual is also a patient may automatically retrieve (synchronize) the individual's updated images and/or other data to keep the local data in the local repository (124A-124N) up-to-date. The automatic updating of the cloud repository (114) and/or synchronization of the pertinent local repositories (124A-124N) may be triggered every time the individual's medical images and/or other data are updated in the cloud, or may be triggered at predetermined intervals.

At times, the connection between one or more of the in-network healthcare facilities and the cloud (110) may get disconnected. In this state, the application may automatically configure the affected local computers (126A-126N) and local servers (122A-122N) at the disconnected healthcare facility to access the local data stored in the local repository (124A-124N). In one or more embodiments of the invention, the disconnected healthcare facility continues to store into the local repository (124A-124N) medical images and/or other data taken or updated during the time of disconnection. This enables the disconnected healthcare facility to establish a continuous workflow without experiencing any downtime caused by the disconnection from the cloud (110).

Then, when the connection between the disconnected healthcare facility and the cloud (110) is reestablished, the local computers (126A-126N) and local servers (122A-122N) of the reconnected healthcare facility may be configured by the application to transmit to the cloud (110) all of the medical images and/or other data stored in the local repository captured or updated during the time of disconnection. Such medical images and/or other data may then be stored in the cloud repository (114) as new remote data. As the cloud (110) is being updated with the medical images and/or other data from the reconnected healthcare facility, the application stored in the local computers (1126A-126N) of the other in-network facilities may automatically update their respective local repositories (124A-124N) with the new remote data.

One skilled in the art will recognize that the architecture of the system (100) is not limited to the components shown in FIG. 1. For example, the server (112) and the repository (114) are not necessarily cloud-based. Instead, the cloud server (112) and the cloud repository (114) may be any type of central server and central repository, respectively. For example, a healthcare provider network may maintain its own server(s) and repository(-ies) and they may or may not be cloud-based. Further, the system (100) may include any number of sites (120A-120N) of any size and type, without departing from the invention. Also, a system in accordance with an embodiment of the invention may operate completely without a central server. Such a system may include a number of local repositories, or even a single local repository only.

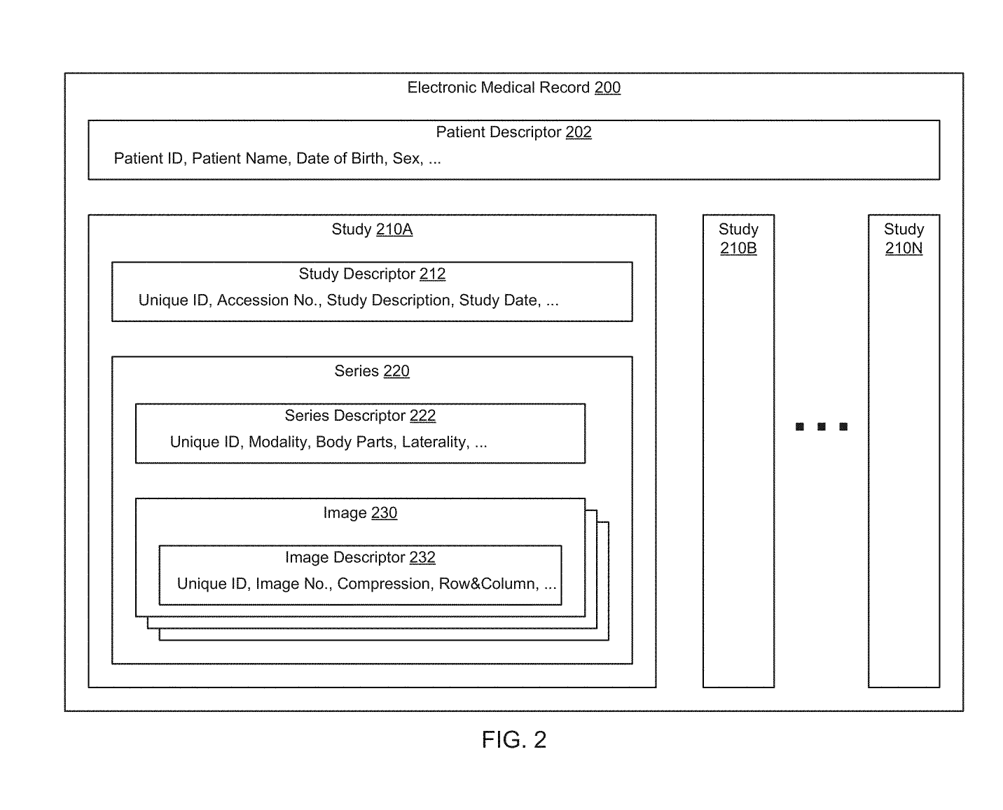

FIG. 2 shows an exemplary electronic medical record in accordance with one or more embodiments of the invention. Such an electronic medical record may be stored in the cloud repository and/or in one or more local repositories. The exemplary electronic medical record may, thus, be a central or a local electronic medical record. In one embodiment of the invention, the electronic medical record is specific to a particular patient and includes at least a patient descriptor (202) and one or more studies (210A-210N). These elements are subsequently described.

In one or more embodiments of the invention, the patient descriptor (202) includes basic patient information or patient demographics such as sex, age and address, etc. The patient descriptor further includes a patient ID that is unique to the patient. The patient descriptor (202) may further include any other type of information that is related to the patient, and that is not necessarily specific to a study (210A-210N).

In one or more embodiments of the invention, a patient study includes information that is related to a patient concern or a patient issue, such as, for example, a sore throat or a bone fracture. To understand and/or address the patient concern/issue, diagnostic and/or therapeutic actions may be performed. For example, diagnostic images may be taken. These images may be stored in series, as further described below.

Those skilled in the art will recognize that, even though the exemplary medical record of FIG. 2 illustrates the storage of images only, other medical data associated with diagnostic and/or therapeutic actions may be stored in an electronic medical record, without departing from the invention. The following list provides a non-limiting set of exemplary studies that may be performed on a patient:
Physical examination—Exploration and observation of the patient's body, typically including auscultation, palpation, manipulation, probing and results of sensory and motor tasks performed by the patient.
Laboratory tests—Chemical, microscopic and microbiological analyses of readily obtained specimens such as blood, urine, saliva, sputum, feces, etc. These may be processed on-site or sent to diagnostic laboratories.
Medical imaging—Use of specialized equipment to obtain planar or 3D representations of the physical tissues of the body such as by X-ray, computed tomography (CT), magnetic resonance imaging (MRI), ultrasound (US), positron emission tomography (PET), impedance tomography, radioisotope imaging, etc. These usually require sending the patient to an imaging machine.
Electrophysiology—Use of specialized instruments to measure electrical signals associated with physiological functions such as electrocardiography (ECG), electroencephalography (EEG), electromyography (EMG), etc. These usually require sending the patient to the instrumentation.
Functional tests (Various physiological functions can be assessed by making various specialized measurements while the patient performs a specific task such as rapid walking, deep breathing, micturition, etc.) These usually require sending the patient to a specialized laboratory.

Each of the above exemplary actions may be performed on a patient for diagnostic and/or therapeutic purposes. Each action may then be documented in the electronic health record as a study (210A-210N).

A study (210A-210N), in accordance with an embodiment of the invention, includes, for example, a description of the diagnostic/therapeutic action, and action results. Depending on the type of the action that was performed, the documentation included in the study may vary, without departing from the invention.

The exemplary study (210A), illustrated in FIG. 2, includes a documentation of an imaging method that was performed on the patient. Assume for example, that a patient arrives in the emergency room with a hip fracture. To properly diagnose the hip fracture, a series of X-ray images is taken. Later additional series of images may be taken to assess the healing process.

A study, in accordance with an embodiment of the invention, includes a study descriptor (212) and one or more series (220). The study descriptor (212) includes descriptive data of the study that is/was performed. The study descriptor may serve administrative purposes and may further enable physicians or other healthcare professionals to obtain information that is related to the study. The study descriptor (212), in one embodiment of the invention, includes a unique identifier (ID), an accession number, a study description and/or a study date. Those skilled in the art will appreciate that the study descriptor (212) may further include any other type of study-related descriptive data.

In one embodiment of the invention, the unique ID serves as a unique identifier of the study. The unique ID may be, for example, an alphanumeric expression that may have been randomly or systematically created. The unique ID may further include the name of the physician or the nurse conducting the study, or any other information that is pertinent to the study.

In one embodiment of the invention, the accession number serves as an identifier of the study. The accession number may be generated at the time when the study is performed or when the study is documented in the electronic medical record. The accession number may be a decimal number, an alphanumerical code, or any other type of identifier suitable for identifying the study.

The study description may provide a general description of the study being performed. In the example of the previously described patient with a hip fracture, the study description may state “hip fracture” without necessarily specifying details regarding the imaging to be performed or having been performed, to properly diagnose the hip fracture. The study date may be the date when the study is/was ordered, when the study is/was executed, when a particular series of a study is/was executed, etc.

As previously noted, a study, in accordance with one or more embodiments of the invention, includes one or more series (220). In the previously introduced example of the patient with the hip fracture, multiple series may be generated over time. For example, an initial series of X-ray images may be generated to diagnose the hip fracture. Multiple additional studies may be generated at later times, e.g., to assess the healing progress.

The series (220), in one embodiment of the invention, includes the series descriptor (222) and one or more images (230). The series descriptor (222) may include any type of data that may be used to document the images (230). For example, the series descriptor may include a modality (e.g., stating that an X-ray or a CT image was taken), body parts that are being imaged, the laterality (providing imaging location information), etc. The series descriptor may further include a unique ID (as previously described). The unique ID associated with the series may differ from the unique ID that identifies the study.

The one or more images (230) may be any type of medical image. In the example of the patient with the hip fracture, the images may be X-ray or CT images. These images may be stored in any format including formats that are commonly used in healthcare, e.g., using the DICOM standard, and/or using any other image format, including commonly used compressed or uncompressed formats such as TIFF, JPEG, etc.

In one embodiment of the invention, an image (230) is accompanied by an image descriptor (232). The image descriptor provides information specific to the image, such as a unique ID, an image number, information regarding image compression, row & column information, the date when the picture was taken, etc.

Although FIG. 2 describes the storage of patient data in the form of a patient medical record, patient data may be stored in other forms, without departing from the invention. For example, in a picture archiving and communication system (PACS), no complete electronic medical record may exist. Further, embodiments of the invention are equally suitable for storing non-imaging data in addition to or as an alternative to imaging data. Further, if the system stores patient data using electronic medical records, it may include additional sections, such as fields for documenting clinical actions and the results thereof. These results may include diagnostic information which may be encoded using, for example, the frequently used International Classification of Diseases (ICD), including ICD-9 or ICD-10. In addition, any data in an electronic medical record may be stored in either encrypted or unencrypted form.

In the subsequent discussion of electronic medical records, the term “electronic medical record data” is used for any data entry in an electronic medical record. Such a data entry may be an image or any other piece of information, including for example, patient information such as the patient's name, a diagnosis, etc. The totality of all electronic medical record data in a patient electronic medical record forms the patient's medical history. Electronic medical record data may be written to or read from a data field of an electronic medical record. If the electronic medical record data includes multiple elements (e.g., an image, and elements of a series descriptor), each of these elements is written to/read from a separate data field (i.e., there is one data field for the image, and one data field for each element of the series descriptor).

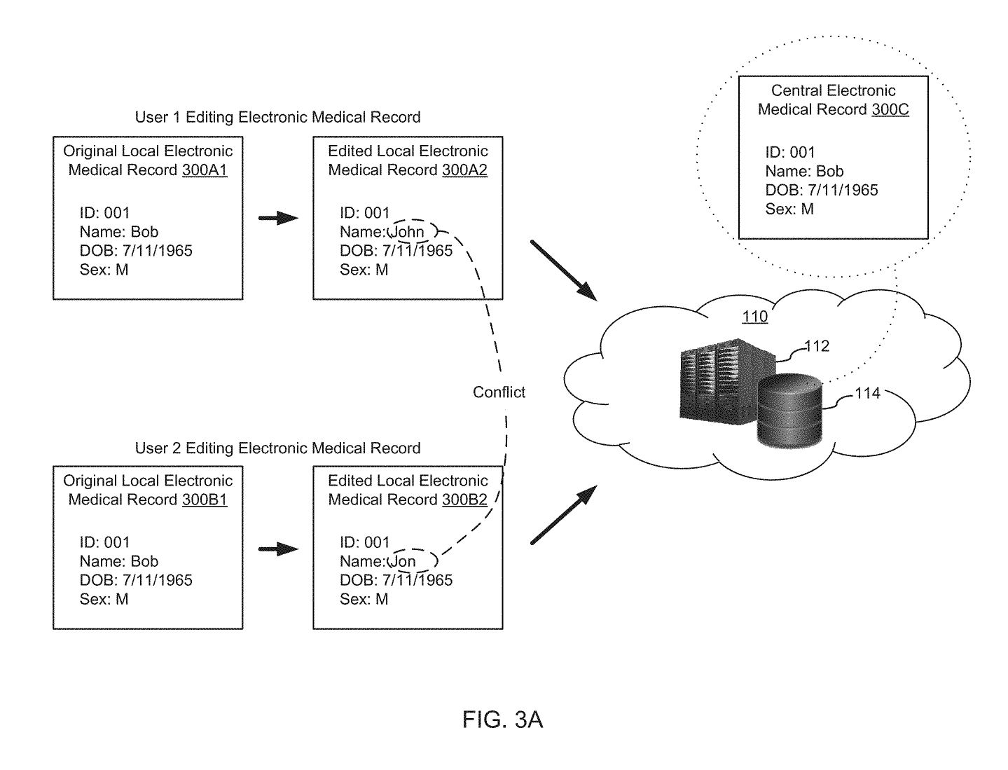

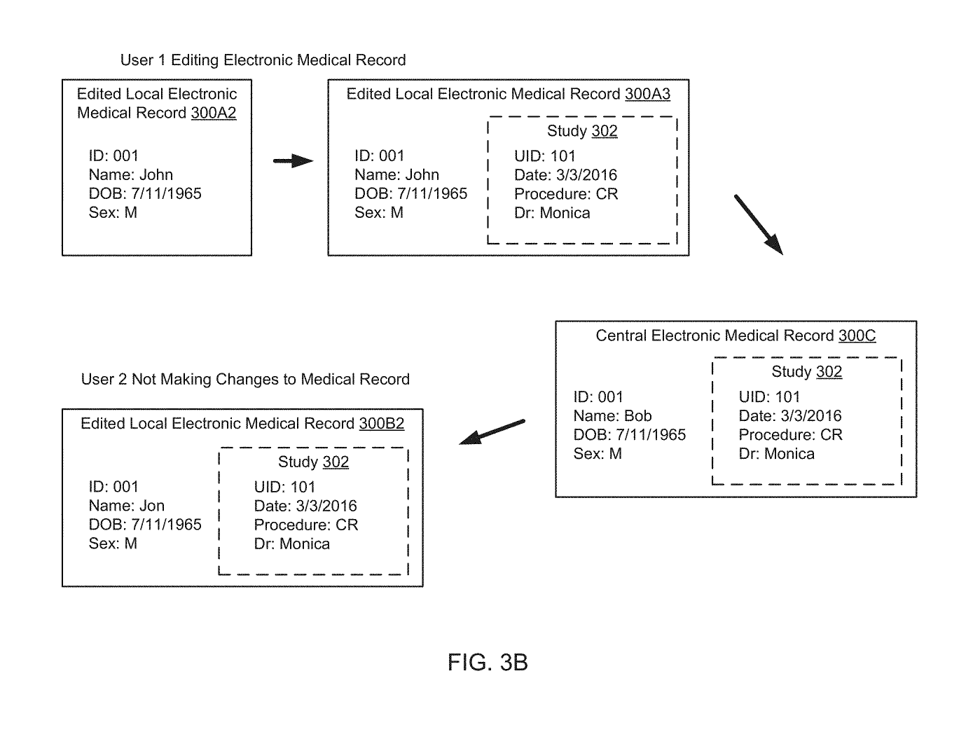

FIGS. 3A and 3B show exemplary scenarios in which a conflict in the electronic medical record data is non-severe, in accordance with one or more embodiments of the invention.

Turning to FIG. 3A, consider a system (100), in which many electronic medical records are centrally stored in the cloud repository (114) of the central server (112). Each of the electronic medical records is uniquely associated with a patient. Further, assume that the electronic medical record of one particular patient is shared with two sites (120A, 120B), for example, because the patient visited both sites. Accordingly, the central electronic medical record (300C) is obtained by both sites (300A, 300B), and is stored in the local repositories (124A, 124B) as local electronic medical records (300A1, 300B1). Unless the local electronic medical records (300A1-300B1) are edited, e.g., by physician via the local computers (126A-126B), the local electronic medical records (300A1, 300B1) are identical to the corresponding central electronic medical record (300C).

Now assume that two parties, user 1 and user 2, are accessing this electronic medical record. Prior to the users making changes to the local copies, they are identical to the central medical record (300C), stored in the cloud repository (114). These local copies are, thus, termed “original local electronic medical records” (300A1, 300B1). The original local electronic medical record (300A1) is now edited by user 1, e.g., by a physician, who updates the name of the patient from “Bob” to “John”, thus resulting in an edited local electronic medical record (300A2). The edited local electronic medical record (300A2) is, thus, no longer identical to the central electronic medical record (300C). To ensure that the changes made to the local electronic medical record (300A2) are available across the system (100), a synchronization of the central electronic medical record (300C) with the local electronic medical (300A2A) is necessary.

Further, the original local electronic medical record (300B1) is edited by user 2, e.g., by a physician, who updates the name of the patient from “Bob” to “Jon”, thus resulting in an edited local electronic medical record (300B2). The edited local electronic medical record (300B2) is, thus, also no longer identical to the central electronic medical record (300C). To ensure that the changes made to the local electronic medical record (300B2) are available across the system (100), a synchronization of the central electronic medical record (300C) with the local electronic medical (300A2A) is necessary.

The synchronization of the central electronic medical record (300C) using the information from the edited local electronic medical record (300A2) and from the edited local electronic medical record (300B2) results in a conflict, due to the spelling discrepancy “John” versus “Jon”.

In one or more embodiments of the invention, a synchronization operation may occur at any time. More specifically, the synchronization of a central electronic medical record with the corresponding local electronic medical record, e.g., after the local electronic medical record has been edited, may occur at scheduled intervals, e.g., every hour or at a particular time of day, etc. The synchronization may further occur in a load-dependent manner, e.g., when system load is low. Alternatively or additionally, synchronization may occur when a trigger event is detected. Such a trigger event may be the detection of the editing of the local electronic medical record, the detection of a discrepancy between content of the local electronic medical record and the corresponding central electronic medical record, the detection of a data connection between the site with the local electronic medical record and the cloud (e.g., when this data connection is restored after an interruption), and/or the detection of a synchronization request submitted by a user, e.g., a clinician accessing the local electronic medical record using a local computer.

In one or more embodiments of the invention, a synchronization operation may be performed for an entire electronic medical record, or for one or more elements of the electronic medical record. In the above-described example of the synchronization shown in FIG. 3A, only the patient's name may be updated during the synchronization, or alternatively, the entire electronic medical record, or sections of the electronic medical record may be updated.

Turning to FIG. 3B, now assume that user 1 makes additional changes to the edited local electronic medical record (300A2). In the example, assume that user 1 adds a study (302) to the edited local electronic medical record (300A2). The addition of the study (302) may be performed at a point in time when the conflict, described in FIG. 3A is already known, or prior to the detection of the conflict. In either case, because the discrepancy in the spelling of the patient's name does not conflict with the addition of the study to the patient's electronic medical record (including the central copy (300C) and the local copies (300A2, 300)), the synchronization of the added study may be performed, even though the synchronization of the patient's name cannot be completed until after a conflict resolution has been performed. Accordingly, while there is a discrepancy in the patient's name, between the different copies of the electronic medical record, all electronic medical records, including the copy accessed by user 2, eventually include the newly added study (302), in accordance with one or more embodiments of the invention.

While the exemplary scenario of FIGS. 3A and 3B illustrates the updating of a central electronic medical record, e.g., a cloud based electronic medical record, the updated electronic medical record may alternatively be located in a local repository, without departing from the invention. Similar updating of an electronic medical record may be performed regardless of whether the electronic medical record is purely cloud based, cloud based with local copies, or purely local.

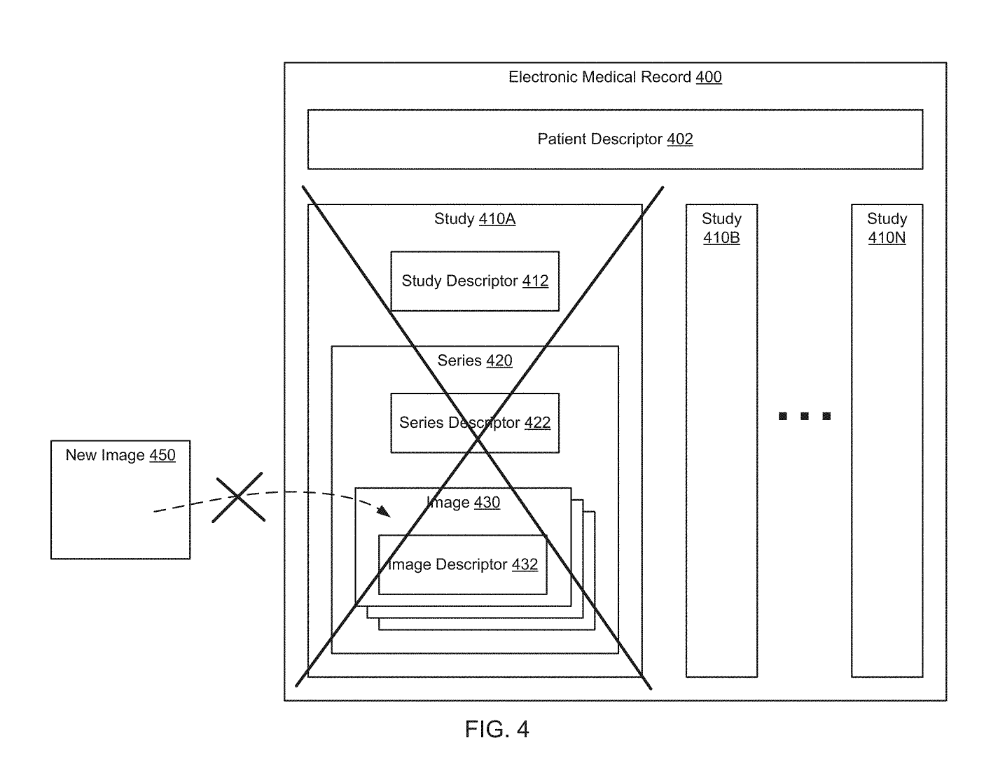

FIG. 4 shows an exemplary scenario in which a conflict in the electronic medical record data is severe, in accordance with one or more embodiments of the invention. Consider an exemplary electronic medical record (400), that includes a patient descriptor (402) and studies (410A-410N). Analogous to the electronic medical record previously introduced in FIG. 2, the study (410A) includes a study descriptor (412), and a series (420). Further, the series (420) includes a series descriptor (422) and one or more images (430), including image descriptors (432). Now, assume that in the discussed scenario, the study (410A) is erroneously deleted by an administrative staff member when performing a maintenance task at a first site. Further, assume that a radiologist at a second site has captured an image (450) which he adds to the series (420). While both actions (the deletion of the study at the first site, and the addition of the image to the study at the second site) are successfully performed in the respective local repositories, once synchronization with the central repository is performed, a severe conflict results because the two actions are irreconcilable. Specifically, it is not possible, on the one hand, to delete the series (420) from the centrally maintained electronic medical record, and on the other hand, to add the image (450) to the series (420) of the same electronic medical record. Accordingly, additional steps, as subsequently described, are necessary to enable successful synchronization.

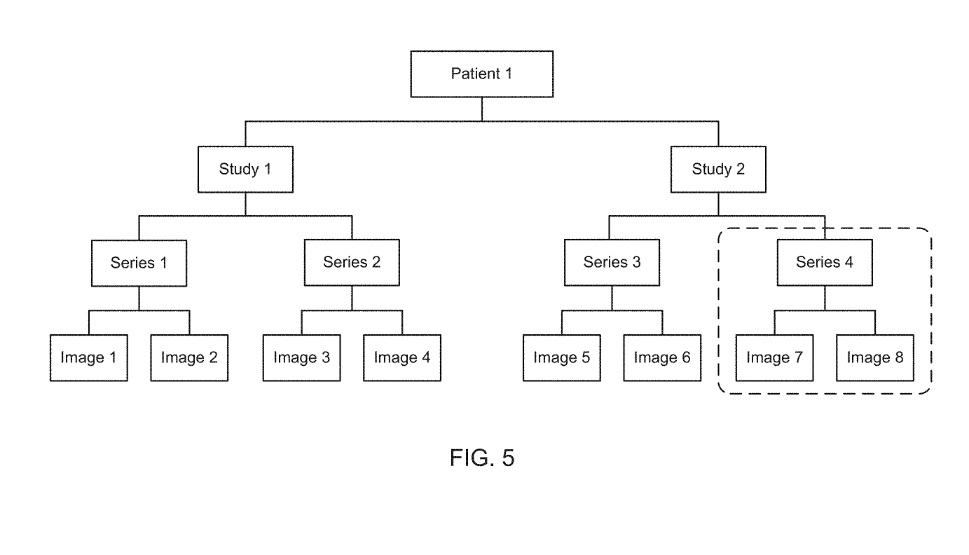

Broadly speaking, an electronic medical record may be understood as a hierarchical structure that includes multiple layers. For example, in FIG. 2, the electronic medical record (200) itself may be the topmost layer, the studies (210A-210N) form intermediate layers, the series (220) for a layer below the intermediate layer, etc. In such a hierarchical structure, severe conflicts may arise when a higher level layer is altered, e.g. renamed, edited, deleted, in a manner preventing insertion of content on a layer that is located below. Such a scenario is described in FIG. 4, and further in FIG. 5, where the hierarchical representation of the medical record is explicitly shown. Alternatively, other changes may be made that do not affect the hierarchical structuring of the layers. While a conflict may still exist due to these changes, they do not prevent operations on one of the layers below, and accordingly the conflict may be considered minor. Such a scenario is described in FIGS. 3A and 3B.

FIG. 5 shows a hierarchical representation of an exemplary electronic medical record, in accordance with one or more embodiments of the invention. The hierarchical representation is subsequently relied upon to further illustrate severe and non-severe conflicts, and differences thereof. The exemplary hierarchical representation is established for a patient “patient 1”. Two studies, “study 1” and “study 2” have been performed on patient 1. Each of these studies includes series. Study 1 includes series 1 and series 2, each of which includes images (image 1, image 2, and image 3, image 4, respectively). Study 2 includes series 3 which includes image 5 and image 6. Further, a series 4 is added to study 2, as further discussed below. Series 4 includes image 7 and image 8.

A scenario with a non-severe conflict, which allows the addition of series 4 to study 2, is now described. Assume that a patient is examined at one facility, while information about the same patient is simultaneously entered at another facility (e.g, a facility the patient visited earlier). Further assume that the information entries that are made at the two facilities are directed to the attributes associated with the patient. For example, the patient's family history may be entered at one of the facilities, and a patient observation such as “walking impairment” is entered at the other facility. Because both entries affect the same category of the medical record (e.g., the patient descriptor, as shown in FIG. 2), a conflict is detected. Next assume that a physician at one of the facilities captures abdominal CT images. Two images (Image 7 and Image 8) are captured in series 4. Series 4, despite the attribute conflict, can be added to Study 2, because the conflict does not prevent the addition to the hierarchical structure and does not cause uncertainty regarding the study being unambiguously associated with patient 1. The conflict is therefore deemed non-severe.

Next, consider a different scenario, in which study 2 has been deleted, either intentionally or accidentally. Assume that, again, the physician captures abdominal CT images that are to be placed under study 2. However, because the conflict, due to the absence of study 2, prevents the addition of the newly captured series 4, including images 7 and 8, the conflict is deemed severe, and the addition of series 4 is therefore prevented, until a conflict resolution has been performed. Such a severe conflict may be triggered for various other reasons as well. For example, a severe conflict may also be triggered because study 2 was renamed or because study 2 was (either intentionally or inadvertently) reassigned to another patient. Any of these actions may generate uncertainty regarding the series to be added being associated with the correct patient and are therefore deemed severe.

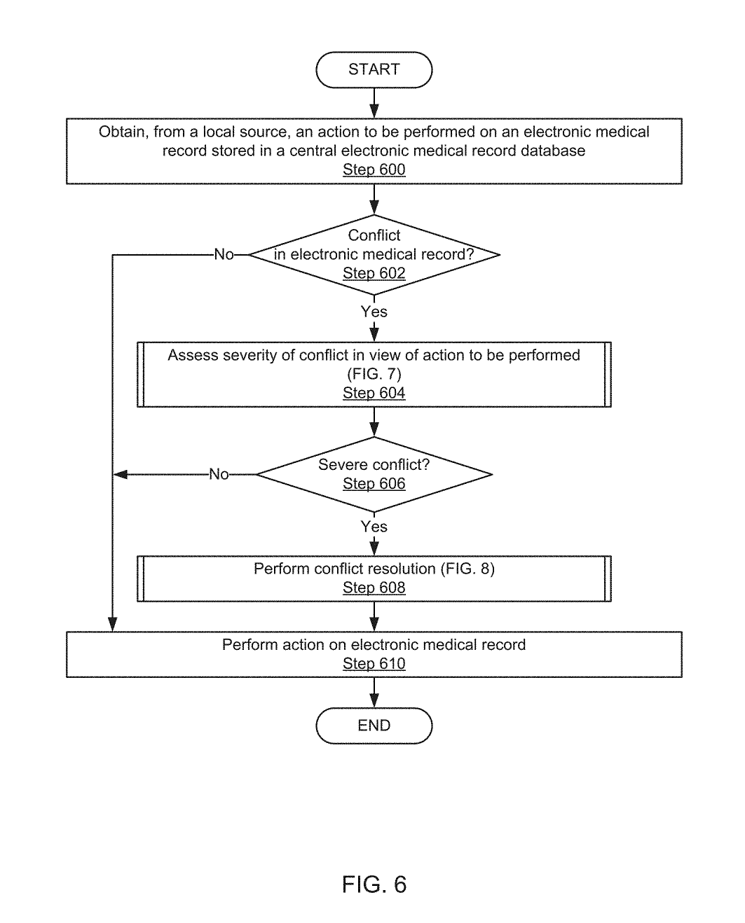

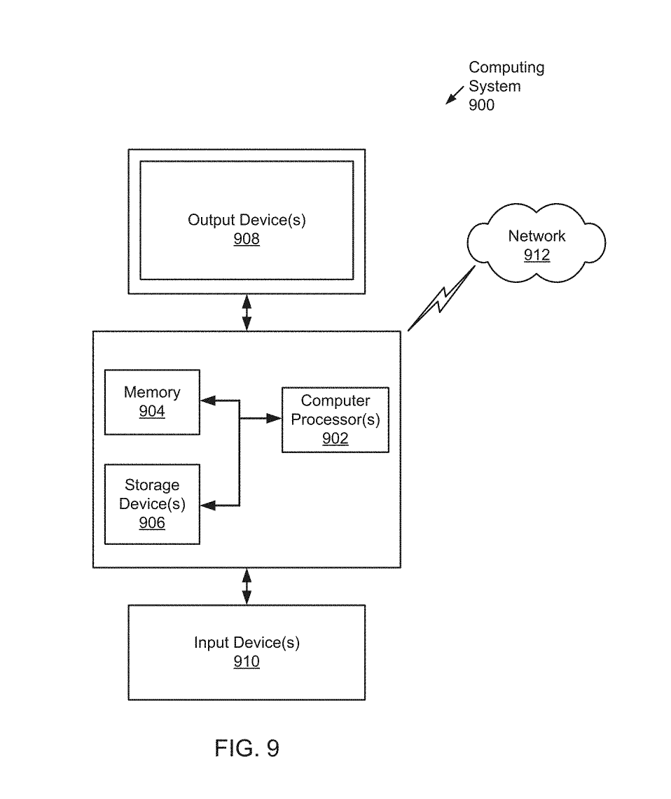

FIG. 6 shows a flowchart in accordance with one or more embodiments of the invention. The process depicted in FIG. 6 may be used for processing electronic medical records when conflicts are present, in accordance with one or more embodiments of the invention. The steps shown in FIG. 6 are performed in an action-specific manner, as subsequently described. In other words, the steps executed for different actions may result in differing outcomes, as the method of FIG. 6 is executed. One or more of the steps in FIG. 6 may be performed by the components of the system (100), discussed above in reference to FIG. 1. In one embodiment of the invention, the steps shown in FIG. 6 may be performed by a conflict resolution engine (not shown), executing on a computing device, e.g., the central server (112) which may be similar to the computing device of FIG. 9. The conflict resolution engine may, thus, include software instructions that implement the method shown in FIG. 6. One or more of the steps shown in FIG. 6 may be executed whenever electronic medical record data in a local repository are updated, thereby requiring the synchronization of the central repository in order to maintain a system-wide current representation of the electronic medical record data.

In one or more embodiments of the invention, one or more of the steps shown in FIG. 6 may be omitted, repeated, and/or performed in a different order than the order shown in FIG. 6. Accordingly, the scope of the invention should not be considered limited to the specific arrangement of steps shown in FIG. 6.

In Step 600, an action is obtained from a local source. The action may be any action that can be performed on an electronic medical record. Actions may thus include, but are not limited to, the addition, removal and editing of electronic medical record data. The action may involve the updating of a single or multiple fields of an electronic medical record, or it may involve the updating of the entire electronic medical record. In one embodiment of the invention, the action was previously performed on a local electronic medical record, located on the local source, and in Step 600, the resulting change is communicated from the local source to the central server, in order to update the central electronic medical record to reflect the content of the local electronic medical record. The electronic medical record data may be obtained by the local source sending the data, e.g., based on a locally occurring trigger event, such as a local user requesting the synchronization of the electronic medical data or a previously defined time interval having expired, as previously described. Alternatively, the electronic medical record data may be obtained by the central server querying the local server that interfaces with the local repository for the electronic medical record.

In Step 602, a determination is made about whether a conflict exists in the electronic medical record data being or having been synchronized to the central electronic medical record. In one or more embodiments of the invention, a conflict is encountered whenever contradictory medical record data is received from different parties when a synchronization of the central medical record is performed. Such contradictions include, but are not limited to: differing data entries for the same field of the electronic medical record obtained from different local sources, and writing of data to a field of an electronic medical record by one local source while the targeted field does either not exist or is being deleted by another local source. The determination may be made based on a comparison of the electronic medical record data obtained from the first local source and the electronic medical record data obtained from the second local source. The action obtained in Step 600 may or may not be the cause of the conflict. Further, the action may be received from one of the first and the second local sources (i.e., from one of the parties responsible for the conflict), or it may be received from a third local source that is not responsible for the conflict. If a determination is made that no conflict exists, the method may directly proceed to Step 610. If, however, a conflict is found, the method may instead proceed with the execution of Step 604.

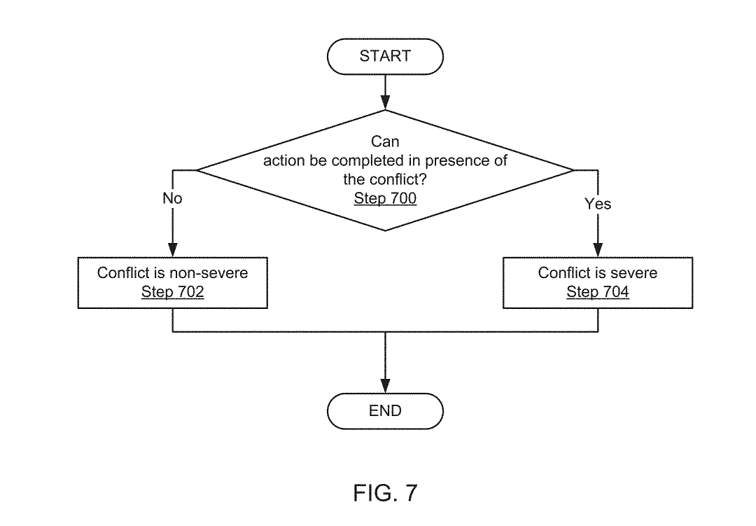

In Step 604, the severity of the conflict in view of the action to be performed is assessed, as described in detail with reference to FIG. 7. Because the assessment is specific to the action to be performed, an assessment performed for another action may have a different severity outcome, and may thus be treated differently in the subsequent steps.

In Step 606, a determination is made about whether the conflict is severe, based on the assessment performed in Step 604. If the conflict is deemed non-severe, the method may directly proceed to Step 610. If, however, the conflict is deemed severe, the method may instead proceed with the execution of Step 608.

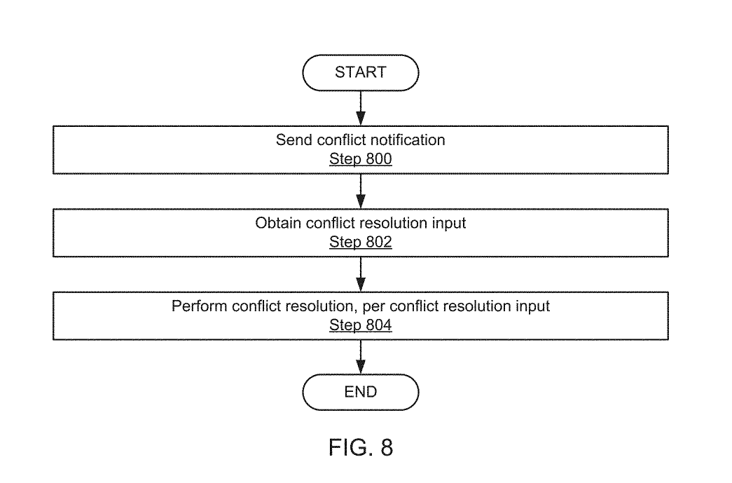

In Step 608, a conflict resolution is performed, as subsequently described with reference to FIG. 8. The conflict resolution, in accordance with one or more embodiments of the invention, addresses the conflict in a manner allowing completion of the action.

In Step 610, the action, originally obtained in Step 600, is performed. If a conflict resolution was performed, i.e., Step 608 was executed prior to Step 610, the execution of the action may be modified based on the conflict resolution performed as described in FIG. 8. For example, while the original action may have been directed to a field of the electronic medical record that does not exist, the modified action, obtained via the conflict resolution, may be directed to an alternative field of the electronic medical record.

FIG. 7 shows a flowchart illustrating a method for assessing the severity of the conflict in accordance with one or more embodiments of the invention. Those skilled in the art will appreciate that, while FIG. 7 shows one method for assessing the severity of a conflict, other methods for assessing the severity of the conflict may be relied upon, without departing from the invention.

In Step 700, a determination is made about whether the action can be completed, in presence of the conflict. If a determination is made that the action can be completed in presence of the conflict, the conflict, in Step 702, is deemed non-severe. An example of such a conflict is provided with reference to FIGS. 3A, 3B and 5, above. Broadly speaking, such conflicts include scenarios in which it is possible to add new information to a lower level in the hierarchically structured electronic medical record, even though a conflict exists on a higher level. Referring to the exemplary electronic medical record of FIG. 2, while there may be a conflict in the patient descriptor (e.g., non-matching patient name, date of birth, etc.), a study may be added to the patient medical record. Similarly, even if there is a conflict in the study descriptor (e.g., non-matching unique ID, accession number, etc.), a series may be added to the study. Also, even if there is a conflict in the series descriptor (e.g., non-matching unique ID, modality, etc.), an image may be added to the series. Accordingly, any conflict that is encountered on a higher level and that does not prevent an action on a lower level in the hierarchically structured electronic medical record is considered non-severe, in accordance with one or more embodiments of the invention. Broadly speaking, conflicts that affect attributes in the medical record, but not the hierarchical structure of the medical record itself, are deemed non-severe because actions may be performed without causing uncertainty, such as a risk that newly added data is accidentally assigned to the wrong patient.

In contrast, if the presence of the conflict prevents completion of the action or may result in improper execution of the action, the conflict, in Step 704, is deemed severe. An example of such a conflict is provided with reference to FIGS. 4 and 5, above, in which the execution of the action is prevented. Further, referring to the exemplary electronic medical record of FIG. 2, additional examples for severe conflicts include the reassignment of a study to an electronic medical record associated with a different patient. Although such a reassignment may be possible, the reassignment may be considered to cause a severe conflict, as soon as an attempt is made to add new information to the moved or reassigned study, because the information to be added may be inadvertently assigned to the electronic medical record of the wrong patient to which the study has been reassigned.

Accordingly, changes of attributes in an existing structure, may cause non-severe conflicts, whereas changes of the structure itself may cause severe conflicts.

FIG. 8 shows a flowchart illustrating a method for performing a conflict resolution in accordance with one or more embodiments of the invention.

In Step 800, a conflict notification is sent. The conflict notification may be sent to, for example, the users responsible for the conflict-causing data, or to a third party, responsible for conflict resolution. The notification may be, for example, an email message, a popup window, a text message sent to, e.g., a portable device, or any other type of message suitable for communicating the conflict.

In Step 802, a conflict resolution input is obtained, e.g., from one of the parties that were contacted in Step 800. A contacted user may, for example, confirm one set of data as correct, while rejecting the other set of data as incorrect. Alternatively, the conflict resolution may involve manipulation of the action to be performed. Consider, for example, an action that specifies that a newly captured medical image is to be stored in a particular series of images. However, this series of images does not exist, thereby causing the conflict. The conflict resolution may thus involve specifying an alternate image series, or creating an image series in which the newly captured medical image can be stored. The response may be provided in various ways. If the notification was provided in a popup window, the popup window may show various options for conflict resolution, from which a user may choose. Alternatively, the user responding to the conflict notification may return to the interface, e.g., a web client, used for entering the conflicting data, to confirm or edit the electronic medical record data as needed to resolve the conflict.

In Step 804, a conflict resolution is performed, per the conflict resolution input. As previously noted, the conflict resolution may be performed in various ways. For example, if the conflict resolution input selects one set of data as the data to be written to one or more fields of the central electronic medical record, the writing of these data is performed. Alternatively or additionally, if the conflict resolution input includes instructions for modifying the action in a manner that resolves the conflict, the action is modified based on these instructions. Those skilled in the art will recognize that the above conflict resolutions are merely examples, and that many other conflict resolutions that are specific to the nature of the conflict and/or the action may exist.

FIG. 9 shows a computing system in accordance with one or more embodiments of the invention. Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 9, the computing system (900) may include one or more computer processor(s) (902), associated memory (904) (e.g., random access memory (RAM), cache memory, flash memory, etc.), one or more storage device(s) (906) (e.g., a hard disk, an optical drive such as a compact disk (CD) drive or digital versatile disk (DVD) drive, a flash memory stick, etc.), and numerous other elements and functionalities. The computer processor(s) (902) may be an integrated circuit for processing instructions. For example, the computer processor(s) may be one or more cores, or micro-cores of a processor. The computing system (900) may also include one or more input device(s) (910), such as a touchscreen, keyboard, mouse, microphone, touchpad, electronic pen, or any other type of input device. Further, the computing system (900) may include one or more output device(s) (908), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (900) may be connected to a network (912) (e.g., a local area network (LAN), a wide area network (WAN) such as the Internet, mobile network, or any other type of network) via a network interface connection (not shown). The input and output device(s) may be locally or remotely (e.g., via the network (912)) connected to the computer processor(s) (902), memory (904), and storage device(s) (906). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (900) may be located at a remote location and connected to the other elements over a network (912). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Various embodiments of the invention have one or more of the following advantages. Even if a conflict exists in an electronic medical record, certain actions may be performed on the electronic medical record, including synchronization of other data, that are not affected by the conflict. Accordingly, it is no longer necessary to lock an electronic medical record with a known conflict issue, thus improving the efficiency of systems in accordance with one or more embodiments of the invention. Further, changes made to data in the electronic medical record may become available to other users of the system through synchronization operations, even in presence of a conflict, thus improving the timely availability of changes throughout the system. However, should a conflict affect a particular action, this action is blocked, to prevent erroneous data in the electronic medical record. A conflict resolution is then performed to subsequently enable execution of the action. Conflicts are interpreted in an action-specific manner, such that only conflicts that adversely affect an action are blocked, whereas all other actions are allowed, in accordance with one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for electronic medical record processing in presence of conflicts, comprising:
obtaining, from a first local source, a first action to be performed on an electronic medical record stored in a central electronic medical record database;
making a first determination that a first conflict exists in the electronic medical record, and based on the first determination:
assessing the severity of the first conflict in view of the first action to be performed,
wherein the first conflict is deemed severe if the first conflict prevents execution of the first action, and
wherein the first conflict is deemed non-severe if the first conflict does allow execution of the first action; and
making a second determination that the first conflict is non-severe, and based on the second determination, performing the first action on the electronic medical record.

2. The method of claim 1, further comprising:
obtaining, from the first local source, a second action, identical to the first action, and to be performed on the electronic medical record stored in the central electronic medical record database;
making a third determination that a second conflict, different from the first conflict, exists in the electronic medical record, and based on the third determination:
assessing the severity of the second conflict in view of the second action to be performed;
making a fourth determination that the conflict is severe, and based on the fourth determination, performing a conflict resolution, comprising:
providing a conflict resolution notification to a user;
obtaining a conflict resolution input; and
performing the second action on the electronic medical record, per the conflict resolution input.

3. The method of claim 1, further comprising:
obtaining, from the first local source, a second action, different from the first action, and to be performed on the electronic medical record stored in the central electronic medical record database;
making a third determination that the first conflict exists in the electronic medical record, and based on the third determination:
assessing the severity of the first conflict in view of the second action to be performed;
making a fourth determination that the first conflict in view of the second action is severe, and based on the fourth determination, performing a conflict resolution, comprising:
providing a conflict resolution notification to a user;
obtaining a conflict resolution input; and
performing the second action on the electronic medical record, per the conflict resolution input.

4. The method of claim 3, wherein performing the second action per the conflict resolution input comprises one selected from a group consisting of modifying the second action to eliminate the conflict and modifying the electronic medical record to eliminate the conflict.

5. The method of claim 1, further comprising:
obtaining, from the first local source, a second action to be performed on the electronic medical record stored in the central electronic medical record database;
making a third determination that no conflict exists in the electronic medical record, and based on the third determination, performing the second action on the electronic medical record.

6. The method of claim 1, wherein the first action is one selected from a group consisting of adding, editing and deleting data in a data field of the electronic medical record.

7. The method of claim 1, wherein the first conflict is a result of obtaining mismatching electronic medical record data obtained from a second and a third local source.

8. The method of claim 1, wherein the first conflict is a result of an incompatibility of the first action with a second action to performed on the electronic medical record and obtained from a second local source.

9. A non-transitory computer-readable medium (CRM) storing instructions that cause a computing system to perform an operation for electronic medical record processing in presence of conflicts, comprising:
obtaining, from a first local source, a first action to be performed on an electronic medical record stored in a central electronic medical record database;
making a first determination that a first conflict exists in the electronic medical record, and based on the first determination:
assessing the severity of the first conflict in view of the first action to be performed,
wherein the first conflict is deemed severe if the first conflict prevents execution of the first action, and
wherein the first conflict is deemed non-severe if the first conflict does allow execution of the first action; and
making a second determination that the first conflict is non-severe, and based on the second determination, performing the first action on the electronic medical record.

10. The non-transitory CRM of claim 9, further storing instructions that cause the computing system to perform an operation comprising:
obtaining, from the first local source, a second action, identical to the first action, and to be performed on the electronic medical record stored in the central electronic medical record database;
making a third determination that a second conflict, different from the first conflict, exists in the electronic medical record, and based on the third determination:
assessing the severity of the second conflict in view of the second action to be performed;
making a fourth determination that the conflict is severe, and based on the fourth determination, performing a conflict resolution, comprising:
providing a conflict resolution notification to a user;
obtaining a conflict resolution input; and
performing the second action on the electronic medical record, per the conflict resolution input.

11. The non-transitory CRM of claim 9, further storing instructions that cause the computing system to perform an operation comprising:
obtaining, from the first local source, a second action, different from the first action, and to be performed on the electronic medical record stored in the central electronic medical record database;
making a third determination that the first conflict exists in the electronic medical record, and based on the third determination:
assessing the severity of the first conflict in view of the second action to be performed;
making a fourth determination that the first conflict in view of the second action is severe, and based on the fourth determination, performing a conflict resolution, comprising:
providing a conflict resolution notification to a user;
obtaining a conflict resolution input; and
performing the second action on the electronic medical record, per the conflict resolution input.

12. The non-transitory CRM of claim 11, wherein performing the second action per the conflict resolution input comprises one selected from a group consisting of modifying the second action to eliminate the conflict and modifying the electronic medical record to eliminate the conflict.

13. The non-transitory CRM of claim 9, wherein the first action is one selected from a group consisting of adding, editing and deleting data in a data field of the electronic medical record.

14. The non-transitory CRM of claim 9, wherein the first conflict is a result of obtaining mismatching electronic medical record data obtained from a second and a third local source.

15. A computing system that processes electronic medical records in presence of conflicts, comprising a central server; and
a central repository associated with the central server,
wherein the central server:
obtains, from a first local source, a first action to be performed on an electronic medical record stored in a central electronic medical record database in the central repository;
makes a first determination that a first conflict exists in the electronic medical record, and based on the first determination:
assesses the severity of the first conflict in view of the first action to be performed,
wherein the first conflict is deemed severe if the first conflict prevents execution of the first action, and
wherein the first conflict is deemed non-severe if the first conflict does allow execution of the first action; and
makes a second determination that the first conflict is non-severe, and based on the second determination, performs the first action on the electronic medical record.

16. The computing system of claim 15, wherein the central server further:
obtains, from the first local source, a second action, identical to the first action, and to be performed on the electronic medical record stored in the central electronic medical record database;
makes a third determination that a second conflict, different from the first conflict, exists in the electronic medical record, and based on the third determination:
assesses the severity of the second conflict in view of the second action to be performed;
makes a fourth determination that the conflict is severe, and based on the fourth determination, performs a conflict resolution, comprising:
providing a conflict resolution notification to a user;
obtaining a conflict resolution input; and
performing the second action on the electronic medical record, per the conflict resolution input.

17. The computing system of claim 15, wherein the central server further:
obtains, from the first local source, a second action, different from the first action, and to be performed on the electronic medical record stored in the central electronic medical record database;
makes a third determination that the first conflict exists in the electronic medical record, and based on the third determination:
assesses the severity of the first conflict in view of the second action to be performed;
makes a fourth determination that the first conflict in view of the second action is severe, and based on the fourth determination, performs a conflict resolution, comprising:
providing a conflict resolution notification to a user;
obtaining a conflict resolution input; and
performing the second action on the electronic medical record, per the conflict resolution input.

18. The computing system of claim 17, wherein performing the second action per the conflict resolution input comprises one selected from a group consisting of modifying the second action to eliminate the conflict and modifying the electronic medical record to eliminate the conflict.

19. The computing system of claim 15, wherein the first action is one selected from a group consisting of adding, editing and deleting data in a data field of the electronic medical record.

20. The computing system of claim 15, wherein the first conflict is a result of obtaining mismatching electronic medical record data obtained from a second and a third local source.
